(19) United States
(12) Patent Application Publication
(10) Pub. No.: US 2017/0199698 A1
(43) Pub. Date: Jul. 13, 2017

(54) INTRA-STORAGE DEVICE DATA TIERING

(71) Applicant: Lenovo Enterprise Solutions (Singapore) PTE. LTD., New Tech Park (SG)

(72) Inventor: James Gabriel Brewington, Morrisville, NC (US)

(21) Appl. No.: 14/991,444

(22) Filed: Jan. 8, 2016

(51) Int. Cl. G06F 3/06

(52) U.S. Cl. CPC G06F 3/0638; G06F 3/0604; G06F 3/0647; G06F 3/0676; G06F 3/0679; G06F 3/0689; G06F 3/0688

(57) ABSTRACT

Data is stored on a storage device, such as one or multiple hard disk drives, in accordance with intra-storage device data tiering. Data to be written to the storage device is received. Whether the data is hot data or cold data is determined. In response to determining that the data is hot data, the data is written to a fastest region of the storage device. In response to determining that the data is cold data, the data is written to a region of the storage device other than the fastest region. The intra-storage device data tiering moves data between the fastest region of the storage device and the region of the storage device other than the fastest region, as opposed to copying data between the fastest region and the region other than the fastest region in a caching-type manner.

### BACKGROUND

Data is the lifeblood of many entities like businesses and governmental organizations, as well as individual users. There is a large variety of different storage devices on which data can be stored. Traditionally, hard disk drives have been employed to store data. More recently, solid-state drives are also being used to store data, which are generally faster but more expensive than hard disk drives and typically have less capacity than hard disk drives. A storage device may include one hard disk drive or one solid-state drive, or may include a group of hard disk drives or a group of solid-state drives. Examples of the latter include redundant arrays of independent disks (RAIDs), storage-area networks (SANs), and network-attached storage (NAS) devices.

### SUMMARY

An example method for intra-storage device data tiering includes receiving data to be written to a storage device. The method includes determining whether the data is hot data or cold data. The method includes, in response to determining that the data is hot data, writing the data to a fastest region of the storage device. The method includes, in response to determining that the data is cold data, writing the data to a region of the storage device other than the fastest region.

An example computing system includes a storage device having a fastest region and a region other than the fastest region. The computing system includes a processor, and a non-transitory computer-readable data storage medium storing computer-executable code that is executable by the processor. The code is executable by the processor to receive data to be written to the storage device. The code is executable by the processor to determine whether the data is hot data or cold data. The code is executable by the processor to, in response to determining that the data is hot data, write the data to a fastest region of the storage device. The code is executable by the processor to, in response to determining that the data is cold data, writing the data to the region of the storage device other than the fastest region.

An example storage system includes a storage device having a fastest region and a region other than the fastest region. The storage system includes a processor, and a non-transitory computer-readable data storage medium storing computer-executable code that is executable by the processor. The code is executable by the processor to receive data from a host computing system to be written to the storage device, the data as received from the host computing system tagged by the host computing system as hot data or cold data. The code is executable by the processor to determine whether the data has been tagged as hot data or cold data. The code is executable by the processor to, in response to determining that the data has been tagged as hot data, write the data to a fastest region of the storage device. The code is executable by the processor to, in response to determining that the data has been tagged as cold data, writing the data to the region of the storage device other than the fastest region.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of an example system in which intra-storage device data tiering is performed.

FIG. 2 is a flowchart of an example method for performing intra-storage device data tiering.

FIG. 3 is a diagram of another example system in which intra-storage device data tiering is performed.

FIG. 4 is a flowchart of another example method for performing intra-storage device data tiering.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background section, data can be stored on storage devices, and a storage device can include one hard disk drive or solid-state drive, or multiple hard disk drives or multiple solid-state drives. The data itself is quite heterogeneous, being generated by different applications for different purposes. For example, some data, such as backup data, is archival in nature, and access to such data may be infrequent. Other data, such as database data, may need to be accessed more frequently. Further, within a particular type of data, some data may be accessed more frequently than other data.

Different techniques have been developed to strategically store and access data based on how often the data is likely to be accessed. One such technique is caching. Caching augments a primary storage device with a cache, which is a volatile or non-volatile storage device that has better performance but usually significantly less storage capability than the primary storage device. When data is to be accessed, it is copied from the primary storage device to the cache, and the copy in the cache is that which is accessed. When the cached copy has been modified, it is written back to the primary storage device so that the copy of the data at the primary storage device is up to date. Caching is thus a copying-oriented technique to strategically store and access data.

Another technique is data tiering. Data tiering generally involves having heterogeneous storage devices with different capacity and performance characteristics, and storing data on the storage device that has appropriate characteristics for the data. For example, a two-tier storage methodology may have a group of solid-state drives and a group of hard disk drives. The former storage devices are faster but of lesser capacity than the latter storage devices. Infrequently accessed data is stored on the hard disk drives, and more frequently accessed data is stored on the solid-state drives. When data stored on the hard disk drives is accessed, it may first be moved to the solid-state drives. Data tiering is thus a moving-oriented technique to strategically store and access data.

A modified data tiering approach involves dividing homogeneous storage devices of the same type but with different performance characteristics. Within the two-tier storage methodology described above, the group of hard disk drives may include hard disk drives rotating at 5,400 rotations per minute (RPM) as well as 7,200 RPM, 10,000 RPM, 15,000 RPM, and so on. The latter hard disk drives are typically faster than the former. Therefore, when it is decided to store data on the hard disk drives as opposed to on the solid-state drives, a further decision is made as to whether to store the data on a faster hard disk drive or a slower hard disk drive.

Another modified data tiering approach operates at the block level instead of at the file level. Whereas traditionally data tiering stores a file completely in one tier of storage devices or another tier of storage devices, this modified data tiering approach can store different blocks of a file over different tiers of storage devices. As with other types of data tiering, data can be moved among the tiers, and within a tier, as needed to provide for the best performance possible of data that is currently being accessed.

Such existing data tiering techniques, however, typically require multiple heterogeneous storage devices, or at a minimum, multiple homogeneous storage devices having different performance characteristics. Existing data tiering techniques cannot be employed in relation to a single storage device, such as a single hard disk drive or a single solid-state drive. Existing data tiering techniques also cannot be employed in relation to multiple homogeneous storage devices having the same performance characteristics, such as multiple hard disk drives that rotate at the same speed. Existing data tiering techniques further assume that a given device, such as a given hard disk drive or solid-state drive, has uniform performance in data access and writing regardless of where the data is stored on the device.

Disclosed herein, by comparison, are techniques that provide for data tiering on a storage device that may include a single drive, such as a single hard disk drive, or multiple drives typically having the same performance characteristics, like multiple hard disk drives configured as a redundant array of independent disks (RAID). The storage device has a fastest region and a region other than the fastest region. For a single hard disk drive, the fastest region may be the outermost concentric track of the drive. For multiple hard disk drives operating as a RAID, the fastest region may be the outermost concentric track of each of the drives.

As such, data tiering can be accomplished on an intra-storage device basis, as opposed to an inter-storage device basis as is conventional. In this sense, a RAID of multiple hard disk drives is considered a single storage device, since the RAID presents itself as a single storage device on which to store data. Hot data is stored on the fastest region of the storage device, and cold data is stored on the other region of the storage device. When hot data becomes cold, it is moved from the fastest region to the other region, and likewise when cold data becomes hot, it is moved from the other region to the fastest region. Hot data is data that is to be accessed most quickly and that is to reside within the highest performance storage data. Cold data is data that is to be accessed less quickly than hot data and that is to reside on a lower performance storage tier.

The techniques thus disclosed herein innovatively extend data tiering to an intra-storage device basis. The techniques disclosed herein particularly leverage, in the context of data tiering, the novel insight that a given storage device, made up of one or multiple drives like hard disk drives or solid state drives, does not have uniform performance characteristics across the device as a whole. For example, hard disk drive performance is related to whether data is stored on one track or multiple tracks. Multiple-track data storage and access is slower than single-track data storage and access, because the drive's read/write head has to be moved between tracks. Hard disk drive performance is further related to the linear velocity of the read/write head relative to the tracks. Because hard disk drives generally rotate at a fixed speed, such as 5,400, 7,200, and so on RPM, the outermost track has better performance and higher capacity than the innermost track.

Furthermore, the techniques disclosed herein can be used in conjunction with conventional, inter-storage device data tiering. For example, a first macro tier may involve a 7,200-RPM hard disk drive and a second macro tier may involve a 5,400-RPM hard disk drive. Within each of these macro tiers, there may be two micro tiers in accordance with the techniques disclosed herein: a first micro tier corresponding to the fastest region of the hard disk drive in a micro tier, and a second micro tier corresponding to the other region of this hard disk drive.

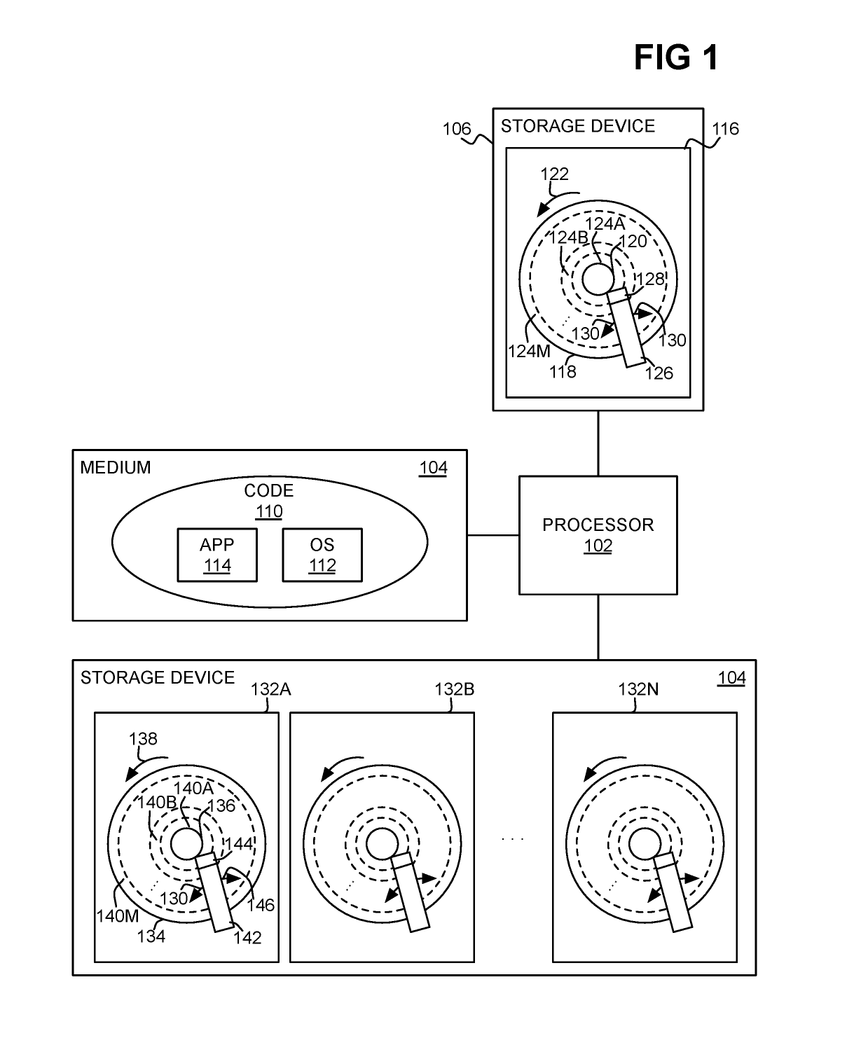

FIG. 1 shows an example system 100 in which intra-storage device data tiering is performed. The system 100 includes a processor 102, a non-transitory computer-readable data storage medium 104, and a storage device 106 and/or a storage device 108. The processor 102 and the medium 104 may be part of a computing device, such as a desktop or laptop computer, and the storage devices 106 and/or 108 may each be an external storage device connected to the computing device over a universal serial bus (USB) connection or other type of connection. In another implementation, the storage devices 106 and/or 108 may each be an internal storage device connected within the computing device over a serial AT attachment (SATA) connection or other type of connection.

The non-transitory computer-readable data storage medium 104 may be the storage device 106 or 108 in one implementation. The medium 104 stores computer-executable code 110 that the processor 102 executes. Specifically, the code includes at least an operating system 112 and an application program 114 that runs on the operating system 112, and which generates data.

The storage device 106 includes a single hard disk drive 116. The hard disk drive 116 has one or more magnetic platters 118 that rotate about a spindle 120, as indicated by the arrow 122. The platters 118 each have a number of concentric tracks 124A, 124B, . . . , 124M, collectively referred to as the concentric tracks 124, from an innermost track 124A to an outermost track 124M. Because the platters 118 rotate at a constant angular velocity, such as 5,400 RPM or 7,200 RPM, the linear velocity at the outermost track 124M is faster than the linear velocity at the innermost track 124A.

The hard disk drive 116 includes an actuator arm 126. At one end of the actuator arm 126 a read/write head 128 is disposed to read from and write to the current concentric track 124 under the head 128. The actuator arm 126 rotates left and right, as indicated by the arrows 130, about the other end of the arm 126. Via rotation of the arm 126, the read/write head 128 is positionable over different concentric tracks 124. While the actuator arm 126 is rotating to position or move the read/write head 128 over a different concentric track 124, it is said that the hard disk drive 116 is in the processing of seeking, as opposed to reading or writing data.

For intra-storage device 106 data tiering, the fastest region of the storage device 106 is the outermost track 124M of the hard disk drive 116. Hot data is stored on this fastest region, and thus on the outermost track 124M of the hard disk drive 116. The other concentric tracks 124 of the hard disk drive 116 constitute the region other than the fastest region of the storage device 106. Cold data is thus stored on this other region. Hot data can therefore be written to the outermost track 124M without having to move the actuator arm 126 to other tracks 124, once the read/write head 128 is positioned over the track 124M.

The storage device 108, by comparison, includes multiple hard disk drives 132A, 132B, . . . , 132N, which are collectively referred to as the hard disk drives 132. The hard disk drives 132 have a common specification. The hard disk drives 132, for instance, may be of the exact same model from the same manufacturer. In general, the hard disk drives 132 may have at least the same specified amount of data storage capacity and the same specified rotational speed.

The hard disk drives 132 are configured as the single storage device 108, such as in a RAID configuration. For example, in a RAID-0 configuration, data is striped across the hard disk drives 132 for maximum capacity and speed, where the total capacity of the storage device 108 is equal to the capacity of each hard disk drive 132 multiplied by the number of hard disk drives 132. As another example, in a RAID-5 configuration, data is striped with parity across the hard disk drives 132 for increased capacity and speed with fault tolerance. The total capacity of the storage device is equal to the capacity of each hard disk drive 132 multiplied by the number of hard disk drives 132 minus one.

Like the hard disk drive 116, each hard disk drive 132 includes one or more magnetic platters 134 that rotate about a spindle 136, as indicated by the arrow 138. The platters 134 each have a number of concentric tracks 140A, 140B, . . . , 140M, collectively referred to as the concentric tracks 140, from an innermost track 140A to an outermost track 140M. Because the platters 134 rotate at a constant angularly velocity, the linear velocity at the outermost track 140M is faster than the linear velocity at the innermost track 140A.

Like the hard disk drive 116, each hard disk drive 132 includes an actuator arm 142. At one end of the actuator arm 142 a read/write head 144 is disposed to read from and write to the current concentric track 140 under the head 144. The actuator arm 142 rotates left and right, as indicated by the arrows 146, about the other end of the arm 142. Via rotation of the arm 142, the read/write head 144 is positionable over different concentric tracks 124.

For intra-storage device 108 data tiering, the fastest region of the storage device 108 is the outermost track 140M of each hard disk drive 132. Hot data is stored on this fastest region, and thus striped over the outermost tracks 140M of the hard disk drives 132. The other concentric tracks 140 of each hard disk drive 132 constitute the region other than the fastest region of the storage device 106. Cold data is stored on this other region, and thus striped over the other concentric tracks 140 of the hard disk drives 132. Hot data can therefore be written to the outermost tracks 140M without having to move the actuator arms 142 to other tracks 140, once the read/write heads 144 are positioned over the tracks 140M.

In the implementation of FIG. 1, the configuration of the hard disk drives 132 as the storage device 108 is performed within the system 100 itself. For instance, the hard disk drives 132 may be configured as a RAID by the operating system 112, such that the operating system 112 performs the striping of data across the hard disk drives 132. This type of RAID is referred to as soft RAID, because it is performed in software and not in dedicated hardware. If the hard disk drives 132 are instead configured as a RAID by a dedicated hardware controller, which is referred to as hardware RAID or hard RAID, the controller can be told by the operating system 112 to which concentric tracks 140 data is to be written, and thus to whether the fastest region or the other region of the storage device 108 the data is to be written. That is, in such an implementation, the operating system 112 is able to control the location (i.e., the concentric track 140) to which data is written at high granularity in communication with the hardware controller managing the RAID.

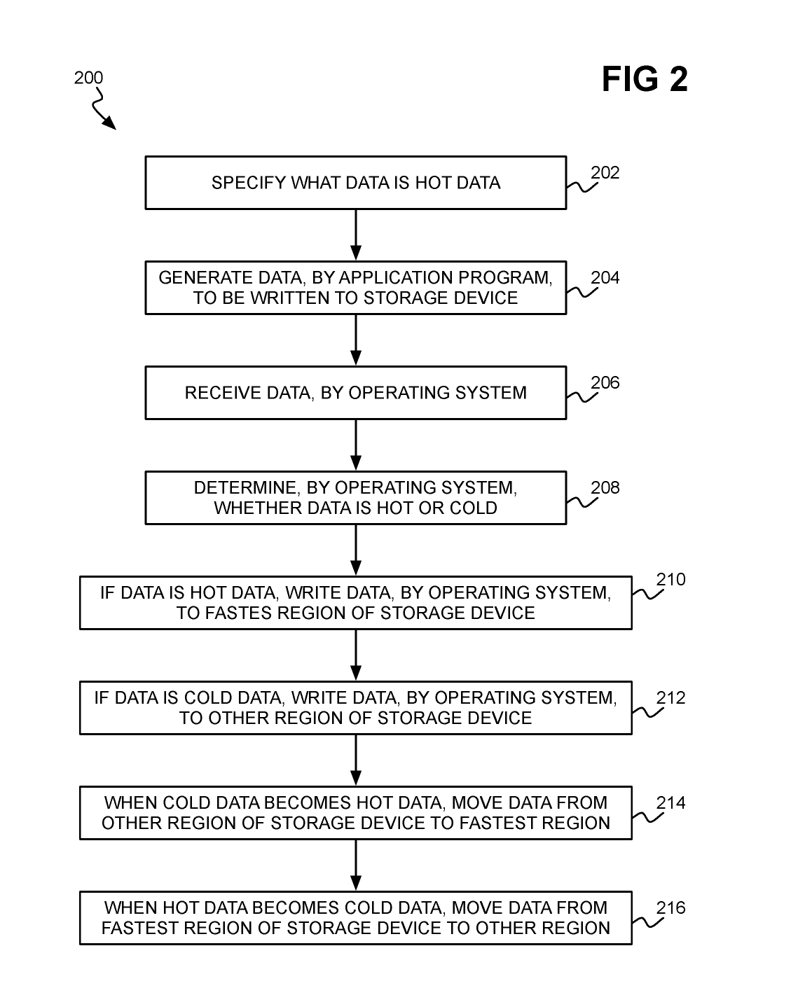

FIG. 2 shows an example method 200 for performing intra-storage device data tiering. The method 200 is performed by a computing device, such as the computing device including the processor 102 and the non-transitory computer-readable medium 104 of FIG. 1. The storage device in relation to which the intra-storage device data tiering is performed can be the storage device 106 or the storage device 108 of FIG. 1.

What data is to be considered hot data, and thus what data is to be considered cold data, is specified (202). That is, what type of data is said to be hot data, and what type of data is said to be cold data, is specified. For example, an operating system running on the computing device may have a preference by which a user can specify which application programs are to be considered as generating hot data. Therefore, the user can select one or more application programs, and data generated by those programs is considered as hot data. Data generated by other application programs is therefore considered as cold data.

As another example, the operating system may have a preference by which the user can further specify the types of data of which application programs that are to be considered hot data. For instance, an application program may generate different types of data. For each of one or more application programs, the user can therefore specify which types of data generated by the application program are to be considered hot data, and which are to be considered cold data. For a web browsing application program, a user may specify that data, including cookie files, generated by certain web sites is hot data, and that data generated by other web site is cold data.

An application program running on the computing device thus generates data to be written to the storage device (204). The operating system receives this data (206), and determines whether the data is hot data or cold data (208). If the data is hot data, the operating system writes the data to the fastest region of the storage device (210), whereas if the data is cold data, the operating systems writes the data to a region of the storage device other than the fast region (212).

Periodically, cold data may become hot, and hot data may become cold.

In the former instance, a user may reconfigure what type of data is considered cold data and what type of data is considered hot data. Therefore, as cold data becomes hot, data is moved from the other region of the storage device to the fastest region (214). Similarly, as hot data becomes cold, data is moved from the fastest region of the storage device to the other region (216).

In the case of the storage device being made up of one or more hard disk drives, as noted above the fastest region can be just the outermost track of each such drive. The amount of data that can be stored on the outermost track is somewhat limited, however. Therefore, the outermost track of the hard disk drive may reach capacity. In such a case, if new hot data is to be written to the outermost track, the oldest hot data (i.e., the data stored on this track that was least recently accessed) may be automatically reclassified as cold data, and moved to one of the other concentric tracks.

In the implementations that have been described above in relation to

FIGS. 1 and 2, the computing device in which the data is generated is responsible for writing the data to the fastest region of the storage device. This means that the computing device has to be able to write to specify, for a storage device including one or more hard disk drives, the track of each hard drive to which the data is written. However, some types of storage devices do not provide for this level of granularity when receiving data to be written.

For example, many types of storage devices that employ hardware RAID, in which a processor or other type of hardware controller of the storage device itself performs the RAID, do not provide this level of granularity when receiving data to be written. A computing device writing data to such a storage device, in other words, cannot specify the track of the storage device's hard disk drive(s) to which data is to be written. Rather, the computing device may just be able to provide the data itself, along with metadata regarding the data, for instance, to the storage device for writing thereto.

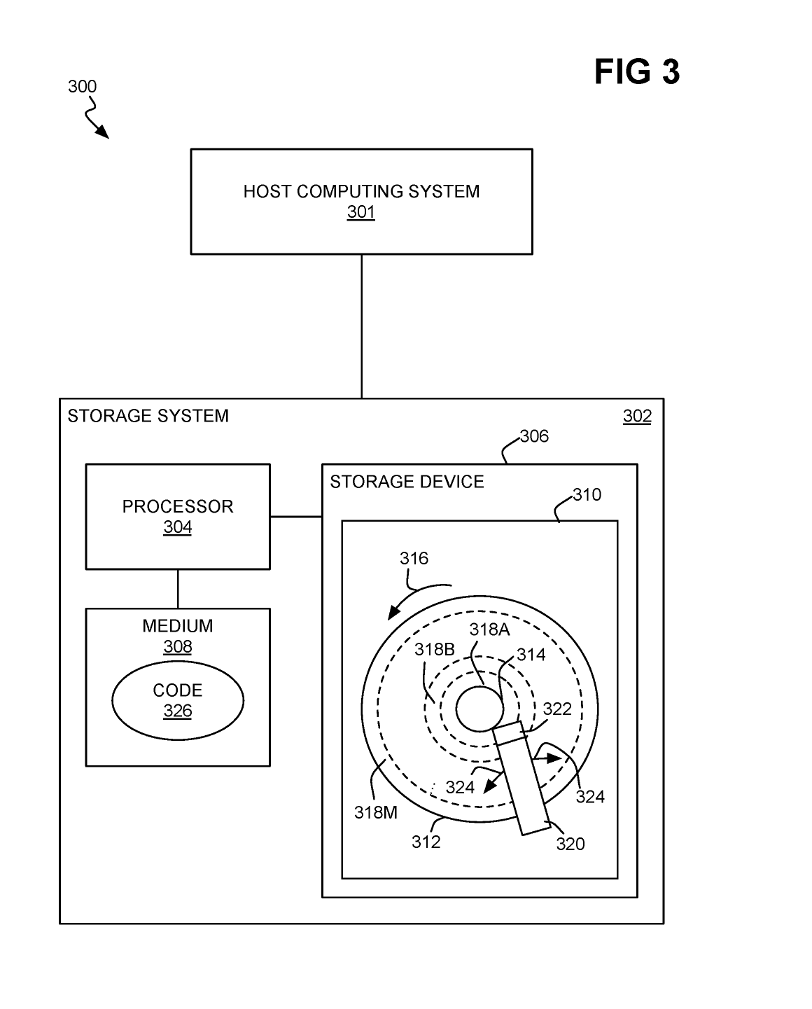

FIG. 3 shows an example system 300 in which intra-storage device data tiering is performed in such cases. The system 300 includes a host computing system 301 and a storage system 302. The host computing system 301 generates the data to be written to the storage system 302. The host computing system 301 may be a computing device, like a desktop or a laptop computer, including a processor, a non-transitory computer-readable medium storing computer-executable code that the processor executes to realize an operating system and one or more application programs, and so on.

The storage system 302 may be a physically separate and external enclosure, or it may be realized as a plug-in peripheral card, such as a RAID card, inserted into the host computing system 301. In the former case, the storage system 302 may be a network attached storage (NAS) device, a storage area network (SAN), or another type of storage system that may expose itself to the host computing system 301 as a single (logical) storage system 302. In general, the host computing system 301 and the storage system 302 are communicatively interconnected with one another, such as over a network, a direct connection such as a USB connection, and so on.

The storage system 302 itself includes a processor 304 or other type of hardware controller, a storage device 306, and a non-transitory computer-readable data storage medium 308 storing computer-executable code 326 that the processor 304 executes. The storage device 306 includes one or more hard disk drives 310. Like the hard disk drive 116 of FIG. 1, each hard disk drive 310 has one or more magnetic platters 312 that rotate about a spindle 314, as indicated by the arrow 316. The platters 312 each have a number of concentric tracks 318A, 318B, . . . , 318M, collectively referred as the concentric tracks 318, from an innermost track 318A to an outermost track 318M.

Each hard disk drive 310 includes an actuator arm 320. At one end of the actuator arm 320, a read/write head 322 is disposed to read form and write to the current concentric track 318 under the head 322. The actuator arm 320 rotates left and right, as indicated by the arrows 324, about the other end of the arm 320. Via rotation of the arm 320, the read/write head 322 is positionable over different concentric tracks 318.

Intra-storage device 306 data tiering is achieved as follows within the system 300. An application program running on the host computing system 301 can generate data, which the operating system running on the host computing system 301 determines to be hot data or cold data. The operating system tags the data as hot data or cold data, such as within metadata regarding the data, and transfers the data as has been tagged to the storage system 302.

Via execution of the code 326 stored on the non-transitory computer-readable data storage medium 308, the processor 304 receives the data. If the data has been tagged as hot data, then the processor 304 stores the data on the fastest region of the storage device 306, such as on the outermost track of the one or more hard disk drives 310. If the data has been tagged as cold data, the processor 304 stores the data on a region of the storage device 306 other than the fastest region, such as on one of the other tracks of the one or more hard disk drives 310.

Therefore, in the system 300, the host computing system 301 does not have to have the capability to be able to write to particular concentric tracks of the hard disk drives 310 of the storage device 306 of the storage system 302. Rather, the host computing system 301 just tags data to be written to the storage system 302 as hot data or cold data. Instead, the storage system 302 itself writes the data that has been tagged as hot data to the outermost track of the hard disk drives 310, and writes the data that has been tagged as cold data to other tracks of the drives 310.

The implementation of FIG. 3 is particularly amenable to a storage system 302 that employs hardware RAID, in which the storage system 302 itself (such as the processor 304 thereof) manages the RAID, as opposed to the operating system of the host computing system 301. In hardware RAID, the hard disk drives 310 may not be individually exposed to the host computing system 301. From the perspective of the host computing system 301, it is writing to a logical storage volume, and the host computing system 301 may not have any knowledge as to how the logical storage volume is realized in actuality. Therefore, in such situations, the implementation of FIG. 3 still permits intra-storage device data tiering to be performed, by offloading the actual writing of data to either the fastest or other region of the storage device 306 to the storage system 302.

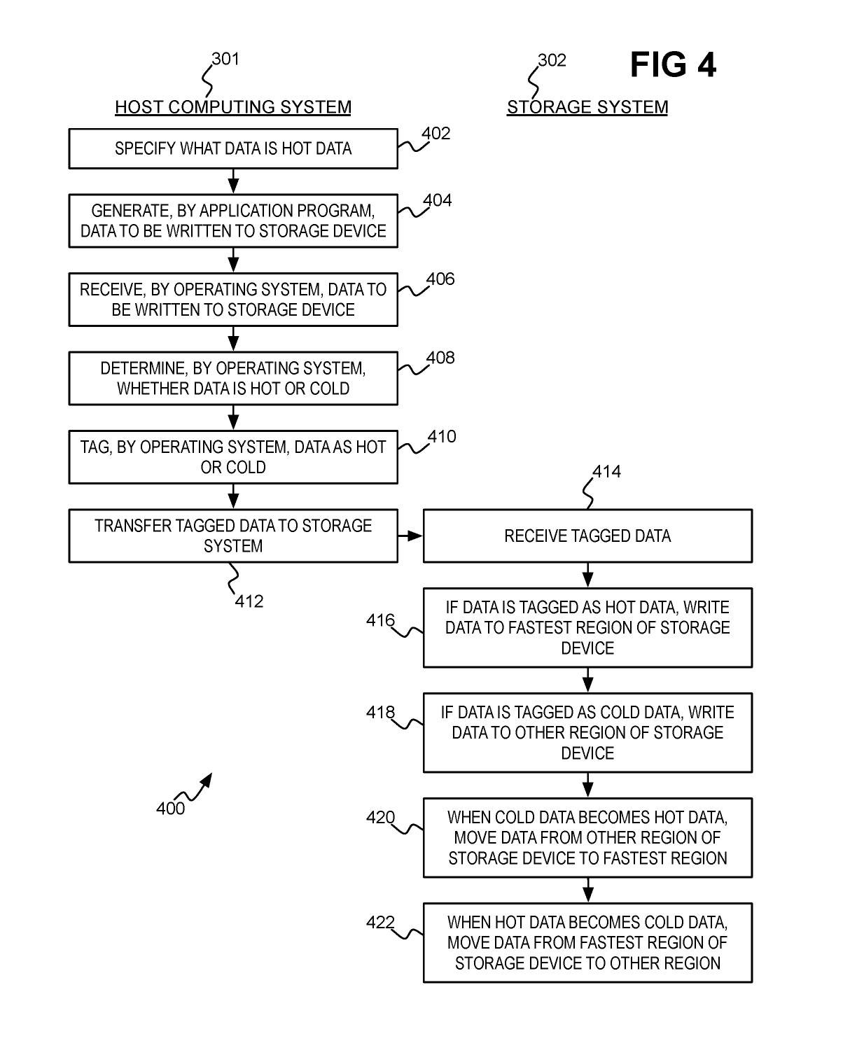

FIG. 4 shows an example method 400 for performing intra-storage device data tiering in the context of a system like that of FIG. 3. The left parts of the method 400 are performed by the host computing system 301, and the right parts of the method 400 are performed by the storage system 302. For instance, the right parts can be performed by the processor 304 executing the computer-executable code 326 from the non-transitory computer-readable data storage medium 308.

What data is to be considered hot data, and what data is to be considered cold data, is specified (402), as has been described above in relation to part 202 of FIG. 2. Similar to parts 204 and 206 of FIG. 2, an application program running on the host computing system 301 generates data to be written to the storage device 306 of the storage system 302 (404), which the operating system running on the host computing system 301 receives (406). The operating system determines whether the data is hot or cold (408), as has been described above in relation to part 208 of FIG. 2.

The operating system tags the data as hot data or cold data (410). For example, the data may be sent from the host computing system 301 to the storage system 302 for storage on the storage device 306 as one or more data packets. Each data packet can include a metadata field as well as a field including the actual data to be stored. Within the metadata field, the operating system may tag the data as hot data or cold data. Such tagging may be achieved with just a single bit. The bit may be set to zero, for instance, if the data is cold data, and set to one if it is hot data.

The host computing system 301 then transfers or sends the tagged data to the storage system 302 for storage on the storage device 306 (412). The storage system 302 thus receives the tagged data from the host computing system 301 and determines whether the data has been tagged as hot data or cold data (414). If the data has been tagged as hot data, the storage system 302 writes the data to the fastest region of the storage device 306 (416), such as on the outermost track(s) 318M of the hard disk drive(s) 310 that constitute the storage device 306. Similarly, if the data has been tagged as cold data, the storage system 302 writes the data to a region of the storage device 306 other than the fastest region (418), such as one of the other tracks 318 of the hard disk drive(s) 310.

As with the method 200, periodically cold data may become hot, and hot data may become cold. Therefore, as cold data becomes hot, the storage system 302 moves the data from the other region of the storage device 306 to the fastest region (420). Similarly, as hot data becomes cold, data is moved from the fastest region of the storage device 306 to the other region (422).

The techniques that have been disclosed herein therefore provide for intra-storage device data tiering. This innovative type of data tiering can be utilized even when the storage device in question consists of just one hard disk drive or other type of drive, or multiple hard disk drives (or other types of drive) having a common specification, neither of which is possible with conventional data tiering techniques. Furthermore, intra-storage device data tiering can be achieved even if the computing device or system within which data is generated for storage cannot specify, for instance, a particular track of a hard disk drive to which to write the data, by offloading some of the functionality to the storage system including the storage device itself.

It is finally noted that, although specific embodiments have been illustrated and described herein, it will be appreciated by those of ordinary skill in the art that any arrangement calculated to achieve the same purpose may be substituted for the specific embodiments shown. For instance, whereas the techniques disclosed herein have been described largely in relation to hard disk drives, the techniques may be applicable to other types of devices, such as solid-state drives, which can individually be or as a group form a storage device, and which have a fastest region and a region other than the fastest region.

For example, solid-state drives are generally manufactured using NAND and other types of flash memory. Different flash memory even of the same type can have different performance and other characteristics, such as latency, throughput, and so on. Therefore, a solid-state drive may have a fastest region corresponding to the fastest flash memory within the drive, and a region other than the fastest region corresponding to slower flash memory within the drive. In this way, the techniques disclosed herein can be applied to solid-state drives as well.

This application is thus intended to cover any adaptations or variations of embodiments of the present invention. Examples of non-transitory computer-readable media include both volatile such media, like volatile semiconductor memories, as well as non-volatile such media, like non-volatile semiconductor memories and magnetic storage devices. It is manifestly intended that this invention be limited only by the claims and equivalents thereof.

We claim:

1. A method for intra-storage device data tiering, comprising:
receiving data to be written to a storage device;
determining whether the data is hot data or cold data;
in response to determining that the data is hot data, writing the data to a fastest region of the storage device; and
in response to determining that the data is cold data, writing the data to a region of the storage device other than the fastest region.

2. The method of claim 1, wherein the storage device is a single hard disk drive comprising:
a spindle;
one or more magnetic platters rotatable around the spindle and having a plurality of concentric tracks;
a read/write head to read from and write to a concentric track of the concentric tracks over which the read/write head is currently positioned; and
an actuator arm to which the read/write head is attached to move the read/write head among the concentric tracks,
wherein the fastest region of the storage device is an outermost concentric track of the concentric tracks of each platter, so that the data is written to the outermost tracks without having to move the actuator arm to other concentric tracks of the tracks.

3. The method of claim 1, wherein the storage device is a single solid-state drive comprising:
flash memory of a first type; and
flash memory of a second type slower than the flash memory of the first type,
wherein the fastest region of the storage device is the flash memory of the first type.

4. The method of claim 1, wherein the storage device comprises a plurality of hard disk drives configured as a redundant array of independent disks (RAID), the hard disk drives having a common specification, each hard disk drive comprising:
a spindle;
one or more magnetic platters rotatable around the spindle and having a plurality of concentric tracks;
a read/write head to read from and write to a concentric track of the concentric tracks over which the read/write head is currently positioned; and
an actuator arm to which the read/write head is attached to move the read/write head among the concentric tracks,
wherein the fastest region of the storage device is an outermost concentric track of the concentric tracks of each platter of each hard disk drive, so that the data is written to the outermost tracks without having to move the actuator arm to other concentric tracks of the tracks.

5. The method of claim 4, wherein the common specification comprises:
a specified amount of data storage capacity; and
a specified rotational speed.

6. The method of claim 1, wherein the storage device comprises a plurality of solid-state drives configured as a redundant array of independent disks (RAID), each solid-state drive comprising:
flash memory of a first type; and
flash memory of a second type slower than the flash memory of the first type,
wherein the fastest region of the storage device is the flash memory of the first type of each solid-state drive.

7. The method of claim 1, wherein a computing device receives the data, determines whether the data is hot data or cold data, and writes the data to the fastest region of the storage device or to the region of the storage device other than the fastest region,
wherein the computing device comprises the storage device as an internal storage device or an external storage device.

8. The method of claim 1, wherein a computing device receives the data and determines whether the data is hot data or cold data, the storage device being part of a storage system communicatively connected to the computing device and having a processor, the method further comprising:
in response to the computing device determining that the data is hot data:
tagging the data as hot data, by the computing device;
sending the tagged hot data from the computing device to the storage system, the processor of the storage system writing the data to the fastest region of the storage device; and
in response to the computing device determining that the data is cold data:
tagging the data as cold data, by the computing device;
sending the tagged cold data from the computing device to the storage system, the processor of the storage system writing the data to the region of the storage device other than the fastest region.

9. The method of claim 1, further comprising:
generating the data, by an application program running on a computing device, an operating system running on the computing device receiving the data to be written to the storage device and determining whether the data is hot data or cold data.

10. The method of claim 1, further comprising:
specifying a data type that encompasses hot data,
wherein determining whether the data is hot data or cold data comprises determining whether the data is of the data type that encompasses hot data.

11. The method of claim 10, wherein specifying the data type that encompasses hot data comprises:
receiving, from a user:
specification of application programs runnable on the computing device that generate hot data;
specification of application programs runnable on the computing device that generate cold data.

12. The method of claim 10, wherein specifying the data type that encompasses hot data comprises:
receiving user input as to which types of data of which application programs runnable on the computing device are to be considered hot data, and as to which types of data of which application programs runnable on the computing device are to be considered cold data.

13. The method of claim 1, further comprising:
when first data stored on the fastest region of the storage device becomes cold data, moving the first data from the fastest region of the storage device to the region of the storage device other than the fastest region; and
when second data stored on the region of the storage device other than the fastest region becomes hot data, moving the second data from the region of the storage device other than the fastest region to the fastest region of the storage device.

14. The method of claim 1, wherein the intra-storage device data tiering moves data between the fastest region of the storage device and the region of the storage device other than the fastest region as opposed to copying the data between the fastest region and the region other than the fastest region in a caching-type manner.

15. The method of claim 1, wherein hot data is defined as data that is to be accessed most quickly and that is to reside on a highest performance storage tier, and cold data is defined as data that is to be accessed less quickly than hot data and that is to reside on a performance storage tier lower than the highest performance storage tier.

16. A computing system comprising:
a storage device having a fastest region and a region other than the fastest region;
a processor; and
a non-transitory computer-readable data storage medium storing computer-executable code that is executable by the processor to:
receive data to be written to the storage device;
determine whether the data is hot data or cold data;
in response to determining that the data is hot data, write the data to a fastest region of the storage device; and
in response to determining that the data is cold data, writing the data to the region of the storage device other than the fastest region.

17. The computing system claim 16, wherein the storage device is a single hard disk drive comprising:
a spindle;
one or more magnetic platters rotatable around the spindle and having a plurality of concentric tracks;
a read/write head to read from and write to a concentric track of the concentric tracks over which the read/write head is currently positioned; and
an actuator arm to which the read/write head is attached to move the read/write head among the concentric tracks,
wherein the fastest region of the storage device is an outermost concentric track of the concentric tracks of each platter, so that the data is written to the outermost tracks without having to move the actuator arm to other concentric tracks of the tracks.

18. A storage system comprising:
a storage device having a fastest region and a region other than the fastest region;
a processor; and
a non-transitory computer-readable data storage medium storing computer-executable code that is executable by the processor to:
receive data from a host computing system to be written to the storage device, the data as received from the host computing system tagged by the host computing system as hot data or cold data;
determine whether the data has been tagged as hot data or cold data;
in response to determining that the data has been tagged as hot data, write the data to a fastest region of the storage device; and
in response to determining that the data has been tagged as cold data, writing the data to the region of the storage device other than the fastest region.

19. The storage system claim 18, wherein the storage device is a single hard disk drive comprising:
a spindle;
one or more magnetic platters rotatable around the spindle and having a plurality of concentric tracks;
a read/write head to read from and write to a concentric track of the concentric tracks over which the read/write head is currently positioned; and
an actuator arm to which the read/write head is attached to move the read/write head among the concentric tracks,
wherein the fastest region of the storage device is an outermost concentric track of the concentric tracks of each platter, so that the data is written to the outermost tracks without having to move the actuator arm to other concentric tracks of the tracks.

20. The storage system claim 18, wherein the storage device comprises a plurality of hard disk drives configured as a redundant array of independent disks (RAID), the hard disk drives having a common specification, each hard disk drive comprising:
a spindle;
one or more magnetic platters rotatable around the spindle and having a plurality of concentric tracks;
a read/write head to read from and write to a concentric track of the concentric tracks over which the read/write head is currently positioned; and
an actuator arm to which the read/write head is attached to move the read/write head among the concentric tracks,
wherein the fastest region of the storage device is an outermost concentric track of the concentric tracks of each platter of each hard disk drive, so that the data is written to the outermost tracks without having to move the actuator arm to other concentric tracks of the tracks.
